(19) United States
(12) Patent Application Publication
(10) Pub. No.: US 2012/0217321 A1
(43) Pub. Date: Aug. 30, 2012

(54) MULTIPLE FLOW SHOWER HEAD

(75) Inventor: Wenjuan Lin, Far Hills, NJ (US)

(73) Assignee: NIAGARA CONSERVATION CORP., Cedar Knolls, NJ (US)

(21) Appl. No.: 13/498,748

(22) PCT Filed: Sep. 28, 2010
(86) PCT No.: PCT/US10/50507

§ 371 Date: May 10, 2012

(30) Foreign Application Priority Data
Sep. 28, 2009 (CN) 200910112581.7
Sep. 28, 2009 (CN) 200920183085.6

(51) Int. Cl. A62C 31/00

(52) U.S. Cl. 239/436

(57) ABSTRACT

A multiple flow shower head (1) is disclosed including a body (Ia) for directing a flow of water, an outlet with a plurality of outlet channels (12a, 12b, 12c) corresponding to a plurality of water flow rates, a rotatable sheath (20) for switching the flow of water through a selected outlet channel, and a corresponding plurality of pressure compensators (3) disposed in the plurality of outlets channels in order to stabilize the flow of water at various flow rates.

### CROSS-REFERENCE TO RELATED APPLICATIONS

The present application claims the benefit of Chinese Application Serial No. 224662, filed Sep. 28, 2009, entitled FLOW RATE SWITCHING DEVICE DESIGNED FOR SHOWERS, and Chinese Application Serial No. 224663, filed Sep. 28, 2009, entitled FLOW RATE SWITCHING DEVICE DESIGNED FOR SHOWERS, the disclosures of which are hereby incorporated herein by reference.

### FIELD OF THE INVENTION

The present invention relates to water-saving products, and more particularly to water-saving shower head devices. Still more particularly, the present invention relates to shower heads capable of various flow rates.

### BACKGROUND OF THE INVENTION

As natural resources continue to dwindle, and particularly water resources, the public has become more conscious of the need for energy savings as well as environmental protection. For this reason and others, water-saving products of various kinds have now been widely accepted. For example, water-saving bubblers are frequently used in people's daily lives, but the current state of the art can only realize water savings by limiting flow rates, and the shower heads known in the art are incapable of switching flow rates while at the same time maintaining stable flow rates with changing water pressure so that the ability to save water is neither stable nor significant.

For example, U.S. Pat. No. 6,126,091 discloses a shower head with both a pulsation and variable flow rate in which a plurality of orifices within the housing creates different water streams by means of a rotary valve within the housing to produce pulsating water streams. Furthermore, U.S. Pat. No. 6,223,998 discloses a shower head and a valve member and mechanism for selectively directing the flow of water directly to nozzle orifices or to drive jets for a water pulsating turbine wheel. However, the search for improved devices has continued unabated.

### BRIEF SUMMARY OF THE INVENTION

In accordance with the present invention, these and other objects have now been realized by the discovery of apparatus comprising a shower head including a body for directing a flow of water, an outlet member associated with the body, the outlet member having a plurality of outlet channels corresponding to a plurality of flow rates for the flow of water, the outlet member including a rotating member for switching the flow of water through a selected one of the plurality of outlet channels, and a corresponding plurality of pressure compensators disposed in the plurality of outlet channels for stabilizing the flow of water at the plurality of flow rates. In a preferred embodiment of the apparatus of the present invention, the apparatus includes a diverter affixed for rotation with the rotating member, the diverter including a plurality of outlet orifices corresponding to the plurality of outlet channels, whereby upon rotation of the rotating member, the diverter directs the flow of water through one of the plurality of outlet orifices. In a preferred embodiment, the apparatus includes a floating cap affixed to the body, the floating cap including an inlet orifice for directing the flow of water through the floating cap and into one of the plurality of outlet orifices in the diverter. In a more preferred embodiment, the floating cap includes a upper surface and a lower surface, the lower surface being proximate to the diverter and including a plurality of slots corresponding to the plurality of outlet channels, and the diverter includes an upper portion proximate to the floating cap and a lower portion, and including a pin member urgingly projecting from the upper surface of the diverter for selected insertion into a selected one of the plurality of slots in the floating cap. In a highly preferred embodiment, the apparatus includes a spring member for urging the pin member from the upper surface of the diverter into the selected one of the plurality of slots in the floating cap.

In accordance with one embodiment of the apparatus of the present invention, the body includes a plurality of body portions including an intermediate body portion rotatably affixed to the body, and wherein the rotating member is affixed to the intermediate body portion for rotation therewith. In a preferred embodiment, the plurality of body portions includes an upper body portion and a lower body portion surrounding the intermediate body portion. In another embodiment, the apparatus includes a ball joint rotatably affixed to the upper body portion.

In accordance with another embodiment of the apparatus of the present invention, the lower body portion is affixed to the intermediate body portion for rotation therewith.

In accordance with another embodiment of the apparatus of the present invention, the apparatus includes a rotatable sheath connected to both the intermediate body portion and the lower portion for rotation therewith. In a preferred embodiment, the apparatus includes a bracket member connected to the upper body portion and surrounding at least a portion of the rotatable sheath.

In accordance with another embodiment of the apparatus of the present invention, the apparatus includes a water body for directing the water outwardly from the apparatus and a water conducting body, the water conducting body means opposed between the diverter and the water body and each of the water body, the water conducting body, and the diverter being attached to the rotatable sheath.

In accordance with another embodiment of the apparatus of the present invention, the plurality of outlet orifices in the diverter includes three outlet orifices. In a preferred embodiment, two of the plurality of pressure compensators are located in two of the three orifices.

In a most preferred embodiment, the apparatus includes a ball joint rotatably affixed to the body, and the third pressure compensator is associated with the ball joint.

In accordance with the present invention, a flow switching device is provided for showers in order to ensure that different flow rates can be used, but that when water pressure changes occur within a predetermined range each of these flow rates remains stable so that effective and stabilized water savings can be realized.

### BRIEF DESCRIPTION OF TEE DRAWINGS

The present invention may be more fully appreciated with reference to the following detailed description, which in turn refers to the Figures, in which:

FIG. 1 is a side, elevational, schematic, sectional view of an apparatus in accordance with the present invention;

FIG. 2 is a side, elevational view of the apparatus shown in FIG. 1;

FIG. 3 is a top, perspective view of the apparatus shown in FIG. 1;

FIG. 4 is a top, elevational view of the apparatus shown in FIG. 1;

FIG. 5 is a bottom, elevational view of the apparatus shown in FIG. 1;

FIG. 6 is a side, perspective, exploded view of the apparatus shown in FIG. 1;

FIG. 7 is a side, elevational, exploded view of the apparatus shown in FIG. 6 in reverse order; and

FIG. 8 is a top, elevational view of a diverter used in the apparatus of the present invention.

### DETAILED DESCRIPTION

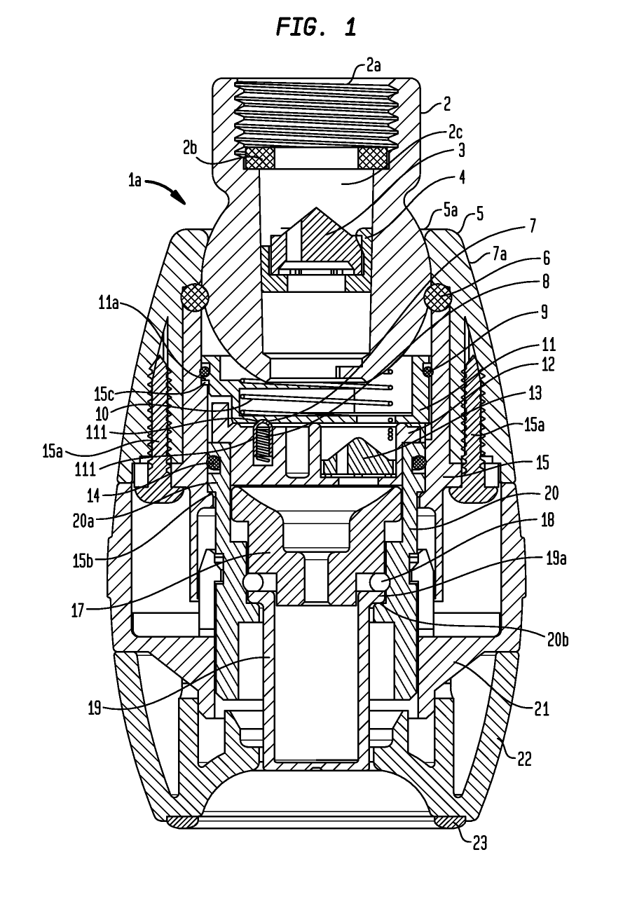

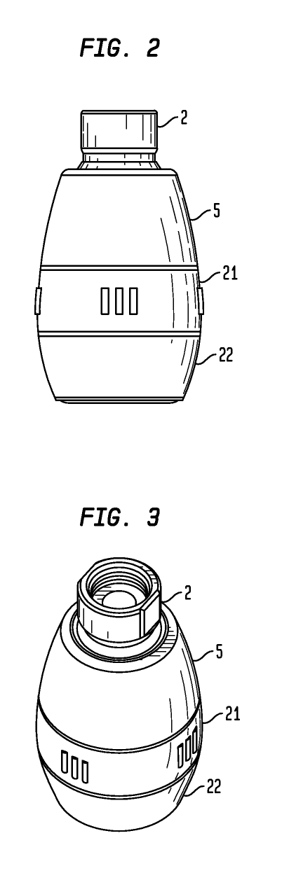

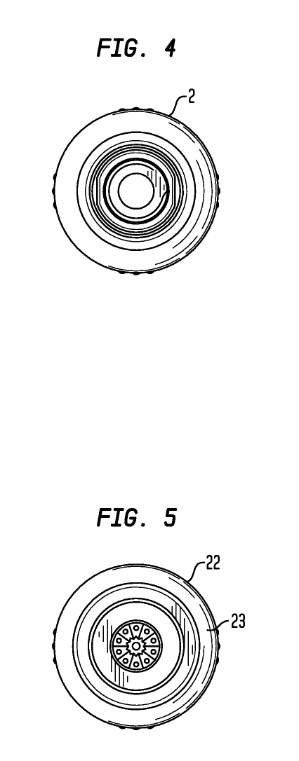

A preferred embodiment of the apparatus of the present invention is shown in the form of the shower head assembly as shown in FIG. 1. As will be discussed in more detail below, this device allows for the use of multiple flow rate outlet orifices with multiple corresponding pressure compensators so that the user can switch to different outlet orifices corresponding to different flow rates, and at the same time these flow rates can be properly controlled by the pressure compensators hereof. Thus, in a preferred embodiment there are three channels which the flow of water can follow, preferably comprising flow rates of 1.5 gallons per minute, 1.0 gallons per minutes, and 0.5 gallons per minutes, each of which has a unique pressure compensator designed to coincide with the particular flow rate therein.

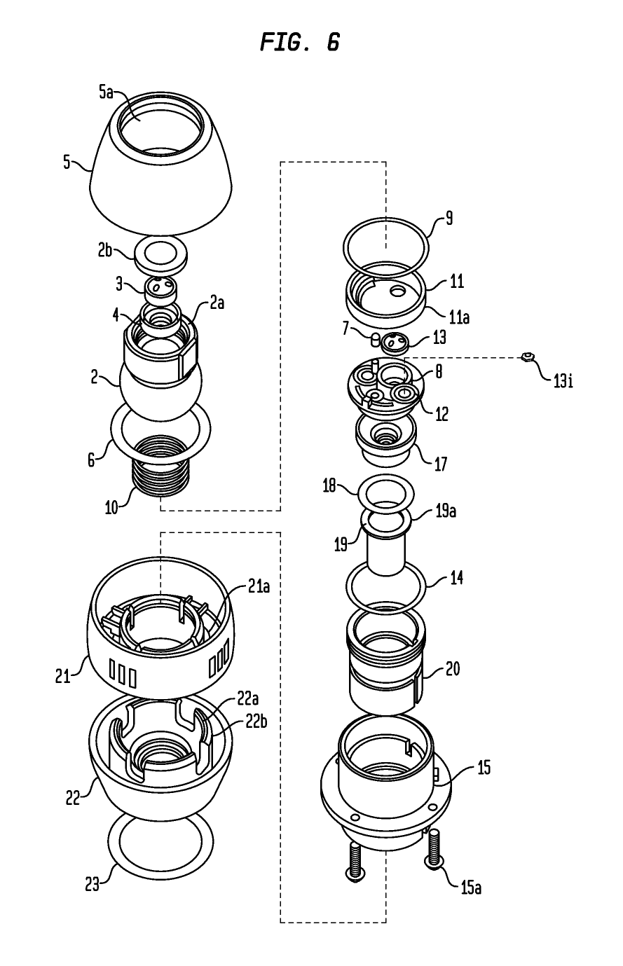

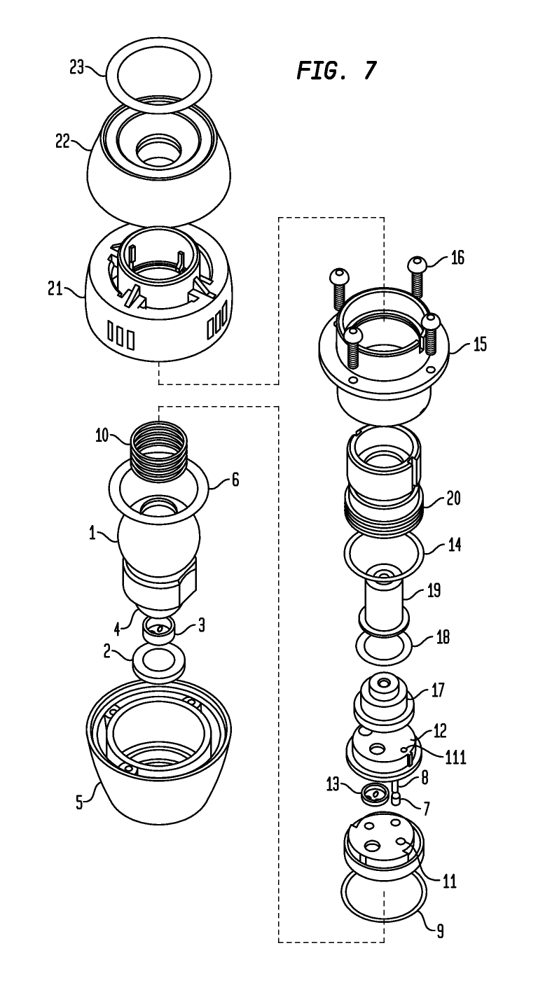

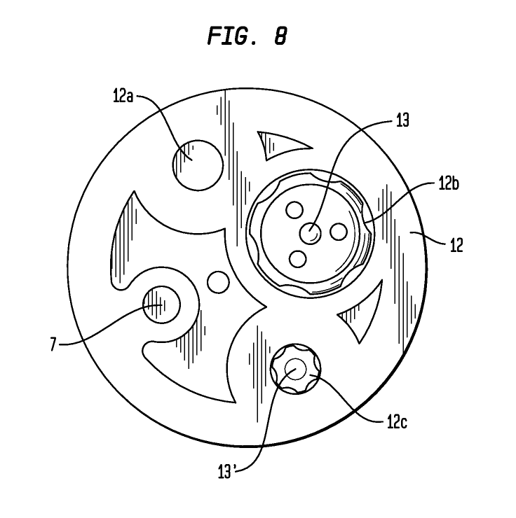

Turning to FIG. 1, which can be seen in an exploded format in FIGS. 6 and 7, the shower head 1 comprises a body 1a which specifically includes an upper body portion 5, an intermediate body portion 21, and a lower body portion 22. The upper body portion 5 includes an opening 5a which contains a ball joint 2 fully rotatable within the upper body portion 5. The upper portion of ball joint 2 includes a threadable portion 2a threadable to a water pipe fixture or the like, and a sealing washer 2b. The intermediate body portion 21 is affixed to the lower body portion 22 by means of fasteners or the like, but more preferably by means of a locking feature. Thus, a series of tabs 22a with upper flanges 22b are inserted into corresponding slots 21a in intermediate body portion 21. This creates a one-way snap-in feature for connecting the lower and intermediate body portions permanently together. Furthermore, the combination of intermediate body portion 21 and lower body portion 22 will be rotatable with respect to the upper body portion 5, as will be discussed in more detail below.

A bracket 15 is installed within the body, affixed to upper body portion 5 by means of bolts such as bolts or screws 15a or the like. Within the bracket 15, and between ball joint 2 and upper body portion 5, is disposed a sealing ring 6 for purposes of sealing the ball joint with respect to the body. The bracket 15 thus extends down to or below the level of upper body portion 5, as shown in FIG. 1. A rotatable sheath 20 is then disposed within the lower depending portion of bracket 15, and is affixed to the intermediate body portion 21 as well as to lower body portion 22 by means of various fasteners or the like. In this manner, the rotatable sheath 20 is maintained within the body, such as by the interaction of outwardly extending flange portion 20a of the rotatable sheath and an inwardly extending flange portion 15b extending inwardly to interact with the flange portion 20a and prevent the rotatable sheath 20 from leaving the body itself. In addition, sealing ring 14 is installed between the rotatable sheath 20 and the bracket 15 within an indented area of the rotatable sheath 20.

Returning to the upper portion of the apparatus, the interior portion of the ball joint 2 includes an open area 2c for the flow of water as it exits the connected pipe or tap (not shown). Within area 2c is mounted affixing bracket 4 holding a first pressure compensator 3 which in this embodiment is the maximum size pressure compensator for the maximum flow within the apparatus itself, such as 1.5 gpm. The pressure compensator 3 itself includes a number of spaced-apart water inlet openings for the flow of water therethrough.

Above the rotatable sheath 20 and below the ball joint 5 is initially mounted a floating cap 11. Between the floating cap 11 and the rotatable bracket 15 a seal 9 is provided. The floating cap 11 is maintained in position relative to the bracket 15 by means of a pressure spring 10 which urges the floating cap 11 downwardly from the ball joint 2. In this manner, the outwardly extending flange 11a of the floating cap 11 is pressed against inwardly extending flange 15c of the bracket 15 in order to do so. Below the floating cap 11 is mounted the diverter 12 which can be specifically seen, for example, in FIG. 8 hereof. The diverter 12 is in contact with the inner surface of the rotatable sheath 20. The lower surface of the floating cap 11 includes positioning slots 111 at predetermined locations thereabout. The upper surface of the diverter 12 includes a projecting pin 7 which is urged upwardly by a positioning spring 8 therewithin. Thus, upon rotation of the diverter 12 along with rotation of the entire intermediate and lower body portions 21 and 22, and thus the rotatable sheath 20, the positioning pin 8 can enter into any one of the positioning slots 111 in the lower surface of the floating ring 11. Each of these positions corresponds to one of the positions, which in a preferred embodiment includes three positions, in which the flow of water through one of the outlet orifices in the diverter 12 can take place. Thus, each corresponds with a different one of the outlet orifices 12a, 12b or 12c in the diverter 12. (See FIG. 8.) In a preferred embodiment as shown in FIG. 1, the outlet orifice 12a corresponds to the maximum flow rate, preferably 1.5 g/m. The flow directed through the opening 2c in the ball joint thus passes through the maximum flow pressure compensator 3 therein before entering orifice 12a.

Upon rotation of the diverter 12 into its second position, where the flow of water from the ball joint 2 enters orifice 12b, this corresponds to the intermediate flow rate of 1.0 g/m, and in this case a second pressure flow compensator 13 is maintained directly within the orifice 12b so that the water will flow directly therethrough,; i.e., after it has also passed through the first pressure flow compensator 3. Finally, in the third position of diverter 12 the orifice opening 12c is in alignment with the flow of water from the ball joint 2, this orifice corresponding to the minimum flow rate of 0.5 g/m. Once again in this case, another pressure compensator 13′ is located within the orifice 12c for control of the flow therethrough.

Below the diverter 12 is mounted a water conducting body 17 for receiving the flow through one of the three outlet orifices in the diverter 12, namely orifice 12a, 12b or 12c, and directing it downwardly. Once again, a sealing ring 18 is installed between the water conducting body 17 and the rotatable sheath 20. Mounted below the water conducting body 17 is water body 19. Water body 19 includes an upper flange portion 19a extending outwardly and interacting with an inwardly extending flange portion 20b extending from the rotatable sheath 20 for maintaining the water body 19 in its desired position therein. The water itself will exit from water body 19 and thus from the entire shower head assembly itself.

The maximum pressure compensator 3 thus ensures that, even with switching of the various flow rates the stability of the flow rate, that is the maximum flow rate itself, will never exceed the rated flow rate for this device. The additional pressure compensators 13 and 13′ ensure the stability of the flow rates through orifices 12b and 12c, namely the intermediate and minimum flow rates. The pressure compensators themselves are the subject of co-pending International Application No. PCT/US2010/41551, filed on Jul. 9, 2010, the disclosure of which is incorporated herein by reference thereto. In general, these pressure compensators are flexible or rubber-like bodies which include orifices or other paths for the flow of water therethrough. These pressure compensators thus compensate for changes in the water pressure by flexing to thereby alter the size of these water channels and maintain the flow rates during said pressure changes.

In operational use of this device, the user will rotate the intermediate and lower body portions, 21 and 22, which thus rotates the rotatable sheath 20 along therewith. Thus, the pin 7 and positioning spring 8 cause the pin 7 to enter one of the positioning slots 111 on the lower body of the floating cap 11 corresponding with one of the outlet orifice 12a, 12b or 12c. Thus, whatever one of the various flow rates, three in this case, is in alignment with the water flow, at least one pressure compensator will ensure that during shifts in the water pressure the flow rate through the outlet orifices remains stabilized, thus achieving stable and water-saving effects thereby. It is, of course, clear that the present invention is not limited to a particular number such as three outlet orifices, but could include more or less outlet orifices depending on the number of different water flow rates which are desired for use therein.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

### INDUSTRIAL APPLICABILITY

The apparatus of the present invention provides plumbing fixtures, in particular shower heads, which are usable with a number of different flow rates, while maintaining the appropriate water pressure at each such flow rate. This provides improved and environmentally appropriate shower heads for home and industrial usage.

1. Apparatus including a body for directing a flow of water, an outlet member associated with said body, said outlet member having a plurality of outlet channels corresponding to a plurality of flow rates for said flow of water, said outlet member including a rotating member for switching said flow of water through a selected one of said outlet channels, and a corresponding plurality of pressure compensators disposed in said plurality of outlet channels for stabilizing said flow of water at said plurality of flow rates.

2. The apparatus of claim 1 including a diverter affixed for rotation with said rotating member, said diverter including a plurality of outlet orifices corresponding to said plurality of outlet channels, whereby upon rotation of said rotating member said diverter directs said flow of water through one of said plurality of outlet orifices.

3. The apparatus of claim 2 including a floating cap affixed to said body, said floating cap including an outlet orifice for directing said flow of water through said floating cap and into said one of said plurality of outlet orifices in said diverter.

4. The apparatus of claim 3 wherein said floating cap includes an upper surface and a lower surface, said lower surface of said floating cap being proximate to said diverter and including a plurality of slots corresponding to said plurality of outlet channels, and said diverter including an upper portion proximate to said floating cap and a lower portion, and including a pin member urgingly projecting from said upper surface of said diverter for selected insertion into a selected one of said plurality of slots in said lower surface of said floating cap.

5. The apparatus of claim 4 including a spring member for urging said pin member from said upper surface of said diverter into said selected one of said plurality of slots in said lower surface of said floating cap.

6. The apparatus of claim 1 wherein said body includes a plurality of body portions including an intermediate body portion rotatably affixed to said body, and wherein said rotating member is affixed to said intermediate body portion for rotation therewith.

7. The apparatus of claim 6 wherein said plurality of body portions includes an upper body portion and a lower body portion surrounding said intermediate body portion.

8. The apparatus of claim 7 including a ball joint rotatably affixed to said upper body portion.

9. The apparatus of claim 7 wherein said lower body portion is affixed to said intermediate body portion for rotation therewith.

10. The apparatus of claim 7 including a rotatable sheath connected to both said intermediate body portion and said lower portion for rotation therewith.

11. The apparatus of claim 10 including a bracket member connected to said upper body portion and surrounding at least a portion of said rotatable sheath.

12. The apparatus of claim 2 including a water body for directing said water outwardly from said apparatus and a water conducting body, said water conducting body being interposed between said diverter and said water body and each of said water body, said water conducting body, and said diverter being attached to said rotatable sheath.

13. The apparatus of claim 2 wherein said plurality of outlet orifices in said diverter includes three outlet orifices.

14. The apparatus of claim 13 wherein two of said plurality of pressure compensators are located in two of said three outlet orifices.

15. The apparatus of claim 14 including a ball joint rotatably affixed to said body, and wherein said third pressure compensator is mounted within said ball joint.
